(19) United States
(12) Patent Application Publication
(10) Pub. No.: US 2014/0104880 A1
(43) Pub. Date: Apr. 17, 2014

(54) LIGHT-EMITTING MODULE AND DISPLAY APPARATUS

(71) Applicants: InnoLux Corporation, Jhu-Nan (TW); INNOCOM TECHNOLOGY (SHENZHEN) CO., LTD, Shenzhen City (CN)

(72) Inventors: Jen-Chih YANG, Jhu-Nan (TW); Cheng-Cheng PAN, Jhu-Nan (TW); Ta-Chin HUANG, Jhu-Nan (TW); Chou-Yu KANG, Jhu-Nan (TW); Pu-Chun CHU, Jhu-Nan (TW)

(73) Assignees: InnoLux Corporation, Jhu-Nan (TW); INNOCOM TECHNOLOGY (SHENZHEN) CO., LTD, Shenzhen City (CN)

(21) Appl. No.: 14/026,267

(22) Filed: Sep. 13, 2013

(30) Foreign Application Priority Data
Oct. 16, 2012 (TW) 101138068

(51) Int. Cl. F21V 8/00

(52) U.S. Cl. CPC G02B 6/0035
USPC 362/611

(57) ABSTRACT

A light-emitting module comprises a light-guiding plate, a plurality of light-guiding elements and a light-emitting unit. The light-guiding plate guides the direction of the light and includes at least a light input surface and two opposite side surfaces. The light-guiding elements e disposed on one of the side surfaces of the light-guiding plate, and disposed corresponding to pixels respectively. The overlooking area of each light-guiding element is larger than zero and less than that of the pixel corresponding to the light-guiding element, by viewing along a direction perpendicular to the side surface. The light-emitting unit is disposed on the light input surface. The light emitted by the light-emitting unit enters the light-guiding plate, and then, by the guiding of the light-guiding plate and the light-guiding elements, is outputted through one of the side surfaces of the light-guiding plate in an alternate form of bright and dark zones.

### CROSS REFERENCE TO RELATED APPLICATIONS

This Non-provisional application claims priority under 35 U.S.C. §119(a) on Patent Application No(s). 101138068 filed in Taiwan, Republic of China on Oct. 16, 2012, the entire contents of which are hereby incorporated by reference.

### BACKGROUND OF THE INVENTION

1. Field of Invention

The invention relates to a light-emitting module and a display apparatus.

2. Related Art

Recently, because the manufacturing process and material of light-emitting diode (LED) are improved unceasingly, the light-emitting efficiency of LED is enhanced enormously. Different from the fluorescent lamp or compact fluorescent lamp, LED has some wonderful characteristics, such as less power consumption, long lifespan, high safety, short response time and small size, thus gradually applied to a lighting apparatus, a lighting case or a lighting module. The lighting apparatus is such as an indoor or outdoor lamp, a flashlight, a headlight or taillight of a vehicle, or other kind of the lighting apparatus. The lighting module can be applied to function as a backlight module of a display apparatus or otherwise.

FIG. 1A is a schematic exploded diagram of a conventional display apparatus 1, and FIG. 1B is a side view of the display apparatus 1.

The display apparatus 1 includes a display panel 11 and a light-emitting module 12. The light-emitting module 12 is a backlight module of the display apparatus 1, emitting the light through the display panel 11 for displaying images.

The light-emitting module 12 is disposed on a side of the display panel 11, and can include two lateral light sources 121, a light-guiding plate 122 and a plurality of light-guiding elements 123. The lateral light sources 121 are instanced as two LED light bars. They are disposed on two opposite sides of the light-guiding plate 122, respectively, and emit the light L entering the light-guiding plate 122 through a light input surface I of the light-guiding plate 122. Each of the light-guiding elements 123 is white ink in a form of an oblique strip, and is disposed on a bottom surface B1 of the light-guiding plate 122 by coating. The light is guided to the center portion of the light-guiding plate 122 from the lateral sides of the light-guiding plate 122 by the total reflection. The light-guiding elements 123 can destroy the total reflection of the light so that the light can be emitted through a light output surface O of the light-guiding plate 122 and towards the display panel 11 for displaying images.

However, when the light L is outputted through the light output surface O of the light-guiding plate 122, the light on the light output surface O is formed into an alternate form of bright and dark oblique strips. By adding the influence of the light-shielding layer (i.e. the opaque black matrix, not shown) disposed in the display panel 11 in the form of strips, the light outputted through the display panel 11 will generate interference fringes (only one interference fringe is shown in the area A of FIG. 1C while the rest are not shown) due to the diffraction, shown by the area A in FIG. 1C (in which the straight strips M are caused by the light L passing through the light-shielding layer, and the oblique strips N are caused by the light on the light output surface O in an alternate form of bright and dark oblique strips). The interference fringes are the so-called Moiré phenomenon, decreasing the display quality of the display apparatus

Therefore, it is an important subject to provide a light-emitting module and a display apparatus that can change the light output form and destroy interference fringes to improve the display quality.

### SUMMARY OF THE INVENTION

In view of the foregoing subject, an objective of the invention is to provide a light-emitting module and a display apparatus that can change the light output form and destroy the interference fringes to improve the display quality.

To achieve the above objective, a light-emitting module of the invention is cooperated with a display panel which includes a plurality of pixels each having a plurality of sub-pixels. The light-emitting module comprises a light-guiding plate, a plurality of light-guiding elements and a light-emitting unit. The light-guiding plate guides the direction of the light and includes at least a light input surface and two opposite side surfaces. The light-guiding elements are disposed on one of the surfaces of the light-guiding plate, and are disposed corresponding to pixels respectively. The overlooking area of each of the light-guiding elements is larger than zero and less than the area of the pixel corresponding to the light-guiding element, by viewing along a direction perpendicular to one of the side surfaces. The light-emitting unit is disposed to the light input surface of the light-guiding plate. The light emitted by the light-emitting unit enters the light-guiding plate. Then, by the guiding of the light-guiding plate and the light-guiding elements, the light is outputted through one of the side surfaces of the light-guiding plate in an alternate form of bright and dark zones.

In one embodiment, each of the light-guiding elements is shaped like a recess or a protrusion by viewing along a direction parallel with one of the side surfaces.

In one embodiment, each of the light-guiding elements is configured with a reflective material.

In one embodiment, the overlooking form of each of the light-guiding elements is a polygon, an ellipse, a circle, a “<” shape, or an irregular form by viewing along the direction perpendicular to the surface where the light-guiding elements are disposed.

In one embodiment, the display panel includes a first pixel and a second pixel, each of which includes at least three sub-pixels. The three sub-pixels are defined as the first sub-pixel, the second sub-pixel, and the third sub-pixel from left to right, the light-guiding elements are defined as a first light-guiding element and a second light-guiding element from left to right, and the first light-guiding element is disposed corresponding to the first sub-pixel of the first pixel while the second light-guiding element is disposed corresponding to the second sub-pixel of the second pixel.

In one embodiment, the display panel includes a first pixel and a second pixel, each of which includes at least three sub-pixels. The three sub-pixels are defined as the first sub-pixel, the second sub-pixel, and the third sub-pixel from left to right, the light-guiding elements are defined as a first light-guiding element and a second light-guiding element from left to right, and the first light-guiding element is disposed corresponding to the first sub-pixel of the first pixel while the second light-guiding element is disposed corresponding to the third sub-pixel of the second pixel.

In one embodiment, the display panel includes a first pixel and a second pixel, each of which includes at least three sub-pixels. The three sub-pixels are defined as the first sub-pixel, the second sub-pixel, and the third sub-pixel from left to right, the light-guiding elements are defined as a first light-guiding element and a second light-guiding element from left to right, and the first light-guiding element is disposed corresponding to the first sub-pixel of the first pixel while the second light-guiding element is disposed corresponding to the first sub-pixel of the second pixel.

In one embodiment, each of the light-guiding elements is disposed corresponding to a sub-pixel, the overlooking area of each of the light-guiding elements is larger than zero and less than or equal the area of the sub-pixel corresponding to the light-guiding element, by viewing along a direction perpendicular to one of the side surfaces.

In one embodiment, the sub-pixels corresponding to the light-guiding elements are disposed such that the geometric centers of the sub-pixels can be connected by a virtual straight line, a virtual oblique line, or a virtual polyline composed of plural line segments.

To achieve the above objective, a display apparatus of the invention comprises a display panel and a light-emitting module. The display panel includes a plurality of pixels each having a plurality of sub-pixels. The light-emitting module is disposed opposite to the display panel and includes a light-guiding plate, a plurality of light-guiding elements and a light-emitting unit. The light-guiding plate guides the direction of the light and includes at least a light input surface and two opposite side surfaces. The light-guiding elements are disposed on one of the side surfaces of the light-guiding plate, and are disposed corresponding to pixels, respectively. The overlooking area of each of the light-guiding elements is larger than zero and less than the area of the pixel corresponding to the light-guiding element, by viewing along a direction perpendicular to one of the side surfaces. The light-emitting unit is disposed to the light input surface of the light-guiding plate. The light emitted by the light-emitting unit enters the light-guiding plate, and then, by the guiding of the light-guiding plate and the light-guiding elements, is outputted through one of the side surfaces of the light-guiding plate in an alternate form of bright and dark zones.

In one embodiment, the light-emitting module is a backlight module of the display apparatus.

In one embodiment, the light-emitting module is a parallax barrier device the display apparatus.

As mentioned above, the display panel of the display apparatus of the invention includes a plurality of pixels, and each of the light-guiding elements of the light-emitting module of the invention is disposed corresponding to a pixel. Besides, by viewing along the direction perpendicular to one of the side surfaces of the light-guiding plate, the overlooking area of each of the light-guiding elements is larger than zero, and less than the area of the pixel corresponding to the light-guiding element. Because the light-guiding elements are disposed corresponding to pixels, respectively, and each of light-guiding elements is with an overlooking area less than the area of the pixel corresponding to the light-guiding element, the light, emitted to the display panel through the side surface of the light-guiding plate, can be formed as curviform in an alternate form of bright and dark zones. Such light can decrease interference fringes caused by diffraction so that the display quality of the display apparatus can be enhanced.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic exploded diagram of a conventional display apparatus;

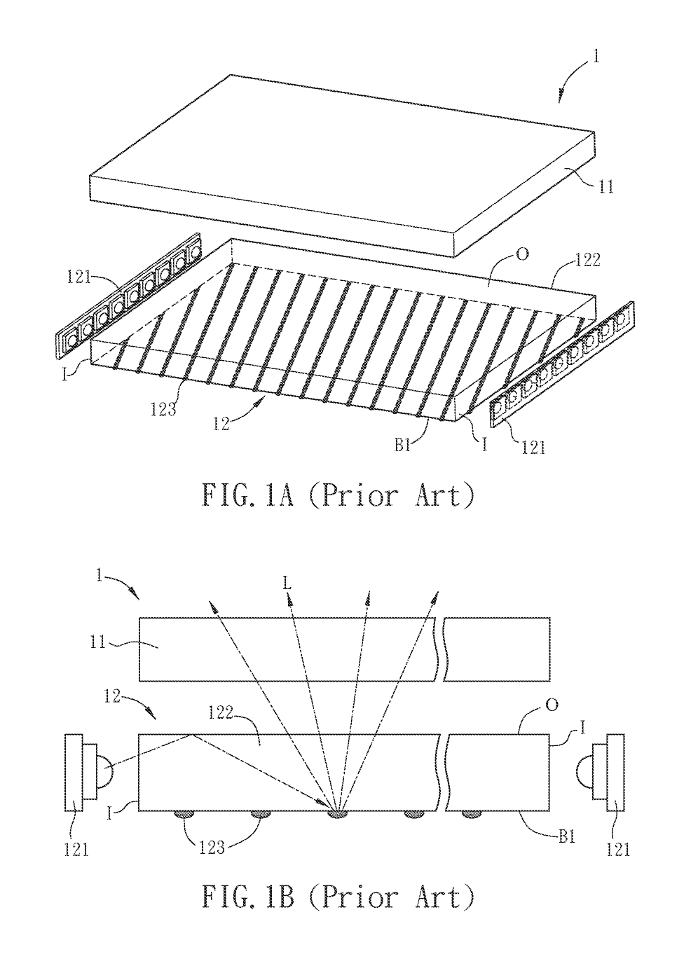

FIG. 1B is a side-view diagram of the display apparatus in FIG. 1A;

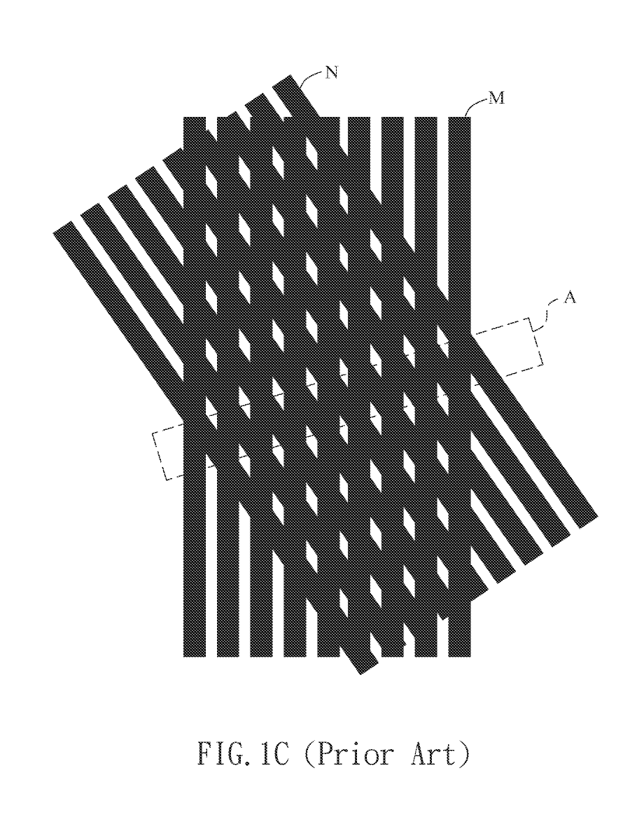

FIG. 1C is a schematic diagram of interference fringes;

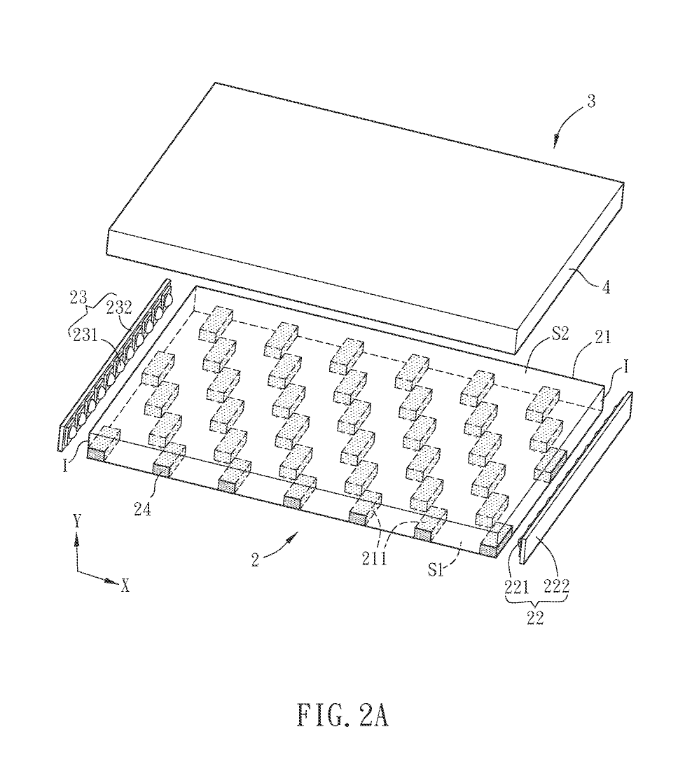

FIG. 2A is a schematic diagram of a display apparatus of a preferred embodiment of the invention;

FIG. 2B is a side view of the display apparatus in FIG, 2A;

FIG. 2C is a schematic diagram of sub-pixels of the display panel and the light-guiding elements in FIG. 2A;

FIG. 2D is a schematic diagram of sub-pixels of another display apparatus and the light-guiding elements of a preferred embodiment of the invention;

FIG. 2E is a side view schematically showing a display apparatus of another embodiment of the invention;

FIG. 3 is a schematic diagram of a display apparatus of another embodiment of the invention; and

FIGS. 4A and 4B are schematic side-views of display apparatuses of other embodiments of the invention.

### DETAILED DESCRIPTION OF THE INVENTION

The present invention will be apparent from the following detailed description, which proceeds with reference to the accompanying drawings, wherein the same references relate to the same elements.

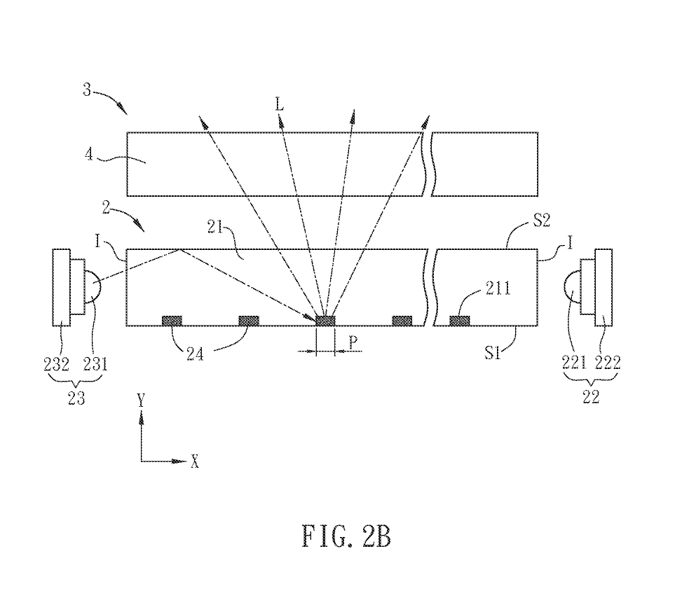

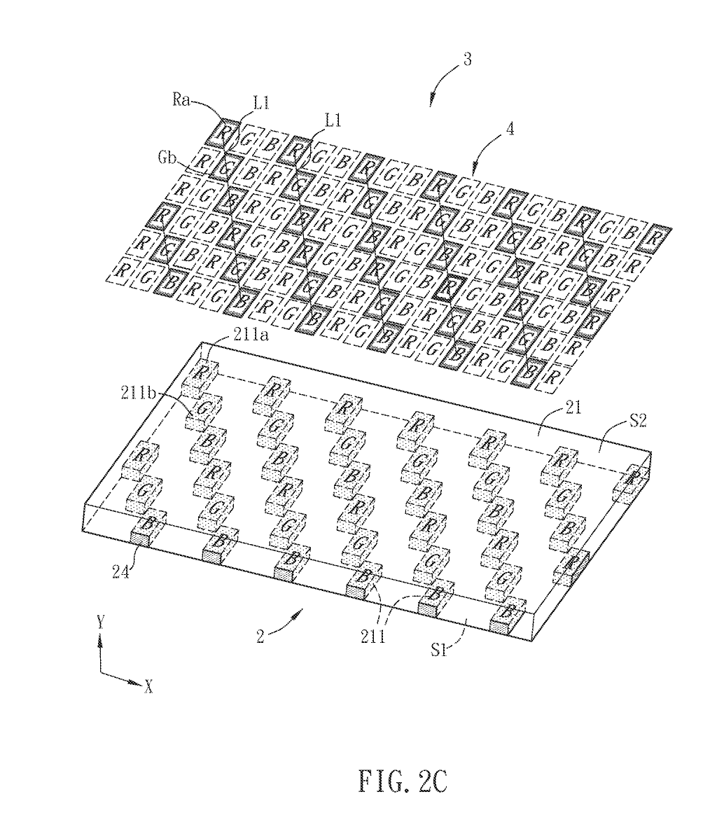

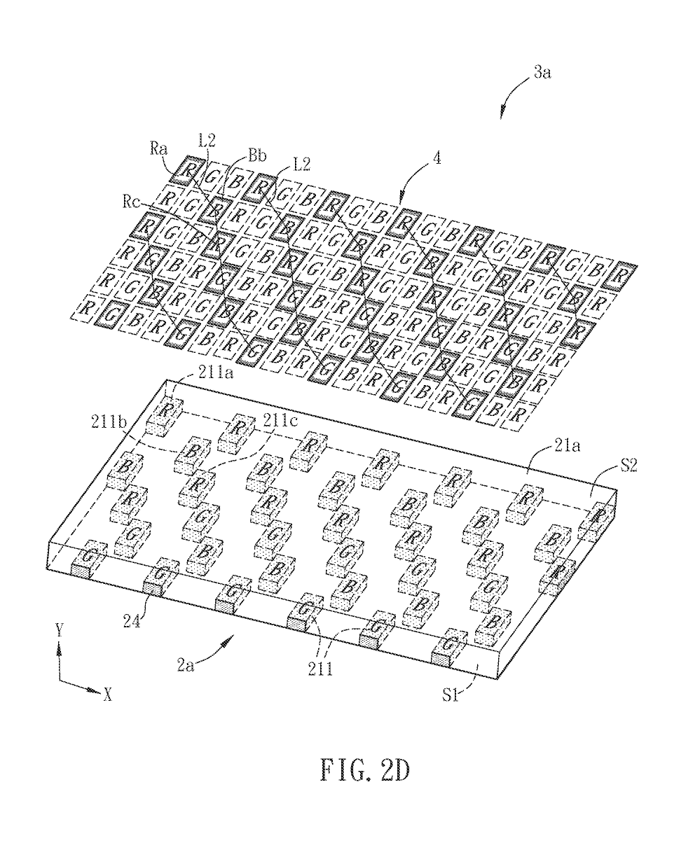

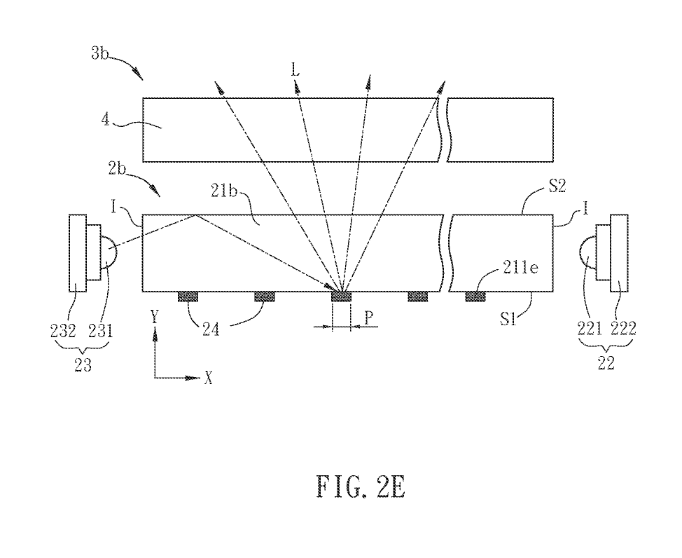

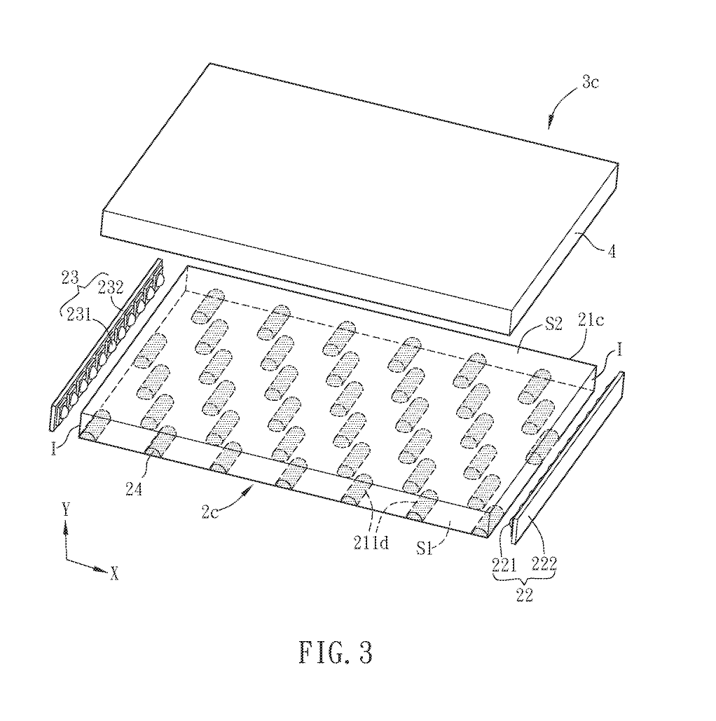

FIG. 2A is a schematic diagram of a display apparatus 3 of a preferred embodiment of the invention, FIG. 2B is a side view of the display apparatus 3, and FIG. 2C is a schematic diagram of sub-pixels of the display panel 4 and the light-guiding elements in FIG. 2A. FIGS. 2A to 2C are just schematic, but not for showing the real dimensions of the objects. Besides, for the clear illustration, FIG. 2C just shows the sub-pixels of the display panel 4, the light-guiding plate 21 and the light-guiding elements, but doesn't show the other elements of the display panel 4.

The display apparatus 3 includes a light-emitting module 2 and a display panel 4. The display panel 4 includes a plurality of pixels. Herein, as shown in FIG. 2C, the pixels of the display panel 4 are formed into a pixel array, and each of the pixels has three sub-pixels R, G, B, for example.

The light-emitting module 2 is disposed opposite to the display panel 4, and includes a light-guiding plate 21, a plurality of light-guiding elements 211, a light-emitting unit and a reflective material 24. In this embodiment, the light-emitting module 2 functions as a backlight module of the display apparatus 3, for example. In other embodiments, the light-emitting module 2 can function as a lighting apparatus, or a parallax barrier device or a parallax prism device that can be applied to a stereoscopic display apparatus to provide the effect of the parallax barrier so that the display apparatus can display stereoscopic (3D) images.

The light-guiding plate 21 can guide the travelling direction of the light, and has at least a light input surface I and two opposite side surfaces S1 and S2. Herein, the surface S1 is the bottom surface of the light-guiding plate 21 while the surface S2 is the top surface of the light-guiding plate 21. The surface S2 of the light-guiding plate 21 in this embodiment is a light output surface, but this is not for limiting the scope of the invention. In other embodiments, the surface S1 (bottom surface) of the light-guiding plate 21 also can function as the light output surface. The light-guiding plate 21 is made of transparent material, such as acrylic resin, polycarbonate, polyethylene resin, or glass, but this invention is not limited thereto. Besides, a cross-section of the light-guiding plate 21 can be plate-shaped or wedge-shaped, for example. A plate-shaped light-guiding plate 21 is instanced here,

The light-guiding elements 211 are disposed to at least one of the surfaces S1 and S2 of the light-guiding plate 21. Herein, the light-guiding elements 211 are disposed to the surface S1 of the light-guiding plate 21. In other embodiments, the light-guiding elements 211 can be disposed to the surface S2 of the light-guiding plate 21. The amount of the light-guiding elements 211 is not limited in the invention. Any two of the light-guiding elements 211 don't intersect, overlap and connect each other.

Each of the light-guiding elements 211 is disposed corresponding to a pixel. In this embodiment, as shown in FIG. 2C, each of the light-guiding elements 211 is disposed corresponding to a sub-pixel. Herein, the light-guiding element 211 is substantially a microstructure that is concaved (i.e. as a recess) towards the surface S2, and can be formed on the surface S1 of the light-guiding plate 21 by etching, optical process, or mechanical process. Otherwise, the light-guiding element 211 can be a convex microstructure. Both kinds of microstructures can achieve similar effects.

In this embodiment, as shown in FIG. 2B, each of the light-guiding elements 211 has an opening along a first direction X (parallel with the surface S1), and the opening has a width P between 50 μm and 150 μm. Besides, a cross-section of each of the light-guiding elements 211 along the first direction X can be curviform, a polygon (including a triangle, a square, a rectangle, a trapezoid, or a regular polygon), or an irregular form. Furthermore, by viewing along the direction (i.e. the second direction Y) perpendicular to the surface S1 where the light-guiding elements 211 are disposed, the overlooking form of each of the light-guiding elements 211 can be, for example, a polygon, an ellipse, a “<” shape, a circle, or an irregular form. The overlooking area of each of the light-guiding elements 211 is larger than zero, and less than the area of the corresponding pixel. Specifically, the overlooking area of each of the light-guiding elements 211 can be less than or equal to the area of the corresponding sub-pixel. Herein, for example, the cross-section of each of the light-guiding elements 211 along the first direction X is instanced as a quadrangle, the overlooking form (i.e. along the direction perpendicular to the surface S1) thereof is instanced as a quadrangle, and the overlooking area thereof is instanced as equal to the area of the corresponding pixel. To deserve to be mentioned, the cross-sections of all the light-guiding elements 211 along the first direction X can be the same or different, or partially the same or partially different. In this embodiment, for example, the cross-sections of all the light-guiding elements 211 along the first direction X are the same in form, and the intervals along the first direction X between any two adjacent light-guiding elements 211 are the same. When the overlooking form of the light-guiding element 211 is the same as the corresponding sub-pixel, the light-emitting module 2 can have the highest utilization efficiency of the light source. The uniformity of the light output of the light-emitting module 2 can be adjusted by adjusting the size of the overlooking area or the depth (or the height) of each of the light-guiding elements 211. In this embodiment, the light-guiding elements 211 are arranged regularly, but they can be arranged with less uniformity (e.g. towards two or more directions) in other embodiments. For example, the light-guiding element 211 can be respectively rotated for an angle on the surface S1 so that they are still disposed corresponding to a sub-pixel respectively but towards two or more directions. The said angle can be less ±90°.

In this embodiment, the display panel 4 includes a first pixel and a second pixel, which each include at least three sub-pixels. The sub-pixels are respectively the first sub-pixel, the second sub-pixel, and the third sub-pixel from left to right, and the light-guiding elements 211 are respectively a first light-guiding element and a second light-guiding element from left to right. Accordingly, the first light-guiding element is disposed corresponding to the first sub-pixel of the first pixel while the second light-guiding clement is disposed corresponding to the second sub-pixel of the second pixel. For example, as shown in FIG. 2C, the first light-guiding element 211a on the light-guiding plate 21 is disposed corresponding to the first sub-pixel R (marked by “Ra”) of the first pixel located on the first row of the display panel 4. To be noted, each of the pixels includes adjacent sub-pixels R, G, B. The second light-guiding element 211b on the light-guiding plate 21 is disposed corresponding to the second sub-pixel G (marked by “Gb”) of the second pixel located on the second row of the display panel 4. By such analogy, the geometric centers of the sub-pixels corresponding to the light-guiding elements 211 can be connected by a virtual straight line, e.g. an oblique line L1, and any two adjacent Oblique lines L1 have the same interval. In other embodiments,the said interval can be different

Referring to FIG. 2B again, the light-emitting unit is disposed on the light input surface I of the light-guiding plate 21. In this embodiment, two light-emitting units 22 and 23 are respectively disposed on the opposite light input surfaces I of the light-guiding plate 21 for example. The light emitted by the light-emitting units 22 and 23 enters the light-guiding plate 21 through the light input surfaces I respectively, and then is outputted through the surface S2 that is opposite to the surface S1. The light-emitting unit 22 or 23 can include, for example, at least a light-emitting diode (LED), at least an organic light-emitting diode (OLED), at least a cold cathode fluorescent lamp (CCFL), or at least a hot cathode fluorescent lamp (HCFL), as a light source of the light-emitting unit 22 or 23. Herein, the light-emitting units 22 and 23 are each instanced as an LED light bar including a plurality of LEDs 221 and 231 respectively disposed on circuit boards 222 and 232. In other embodiments, a single light-emitting unit can be disposed.

Reflective materials 24 are respectively disposed on the light-guiding elements 211, and capable of reflecting the light emitted by the light-emitting units 22 and 23. The reflective material 24 can be disposed on an inner wall of the recess of the light-guiding element 211 or on an outer wall of the protrusion of the light-guiding element 211, or can be disposed in the recess of the light-guiding element 211. Herein, the reflective materials 24 are instanced as disposed in the recesses of the light-guiding elements 211 to the full. In this embodiment, the reflective material 24 in the light-guiding element 211 can destroy the total reflection of the light L so that the light L can be emitted out through the surface S2 of the light-guiding plate 21 (in the case of the reflective material 24 disposed on the outer wall of the protrusion, the reflective material 24 can block the travelling of the light so that the light L can be reflected to other locations through the surface S1) and be reused. The reflective material 24 can include oxide, such as white SiO2, TiO2, or other substances of high reflectance. To deserve to be mentioned, the light-guiding element 211 can be configured without the reflective material 24, so the light L is guided only by scattering and then outputted through one of the side surfaces in an alternate form of bright and dark zones. Accordingly, the light L emitted by the light-emitting units 22 and 23 enters the light-guiding plate 21 through the light input surfaces I, then is spread to the whole light-guiding plate 21 by the total reflection effect in the light-guiding plate 21, and then is outputted through the surface S2 by the light-guiding elements 211 (and the reflective materials 24) disposed on the surface S1.

FIG. 2D is a schematic diagram of sub-pixels of another display apparatus 3a and the light-guiding elements of a preferred embodiment of the invention. Herein, FIG. 2D just shows the sub-pixels of the display panel 4, and the light-guiding plate 21a and the light-guiding elements thereof, but doesn't show the other elements of the display panel 4.

In this embodiment, the display panel 4 includes a first pixel and a second pixel. The light-guiding elements are respectively a first light-guiding element and a second light-guiding element from left to right. The first light-guiding element is disposed corresponding to the first sub-pixel of the first pixel, and the second light-guiding element is disposed corresponding to the third sub-pixel of the second pixel. For example, as shown in FIG. 2D, the first light-guiding element 211a on the light-guiding plate 21a is disposed corresponding to the first sub-pixel R (marked by “Ra”) of the first pixel located on the first row of the display panel 4, and the second light-guiding element 211b on the light-guiding plate 21a is disposed corresponding to the third sub-pixel B (marked by “Bb”) of the second pixel located on the second row of the display panel 4. Besides, the third light-guiding element 211c on the light-guiding plate 21a is disposed corresponding to the first sub-pixel R (marked by “Re”) of the third pixel located on the third row of the display panel 4. The relations of the remaining elements can be deduced by referring to FIG. 2D, so the detailed descriptions are omitted here. Accordingly, the geometric centers of the sub-pixels corresponding to the light-guiding elements 211 can be connected by a virtual polyline L2 composed of plural line segments, and any two adjacent polylines L2 have the same interval. In other embodiments, the said interval can be different. To be noted, the relative locations of the light-guiding elements 211 and sub-pixels R, G, B are just for example, and can be varied in other embodiments. For example, the first light-guiding clement is disposed corresponding to the first sub-pixel of the first pixel while the second light-guiding element is disposed corresponding to the first sub-pixel of the second pixel. Other relative locations also can be allowed in the invention.

Verified by the experiments, for the display apparatuses 3 and 3a of the invention, when the light L is emitted to the display panel 4 through the surface S2 of the light-guiding plate 21 or 21a of the light-emitting module 2 or 2a, it can be prevented from causing diffraction effect with the light-shielding layer (i.e. black matrix) of the display panel 4, by the light-guiding elements 211 which are disposed on the surface S1 of the light-guiding plate 21 or 21a and each corresponding to a pixel (a sub-pixel) (and by the reflection of the reflective material 24), so that the interference fringes are will not occur. Accordingly, the display quality of the display apparatuses 3 and 3a is enhanced.

FIG. 2E is a side view schematically showing a display apparatus 3b of another embodiment of the invention.

Referring to FIG. 2E, different from the display apparatus 3, the light-guiding element 211e of the light-emitting module 2b of the display apparatus 3 is a microstructure of protrusion by viewing along the first direction X (parallel with the surface S1), and the reflective materials 24 are respectively disposed on the outer walls of the protrusions.

Besides, other technical features of the display apparatus 3b as shown in FIG. 2E can be understood by referring to the display apparatus 3 in FIG. 2B, so the detailed descriptions are omitted here.

Furthermore, in another embodiment, the light-emitting module 2, 2a or 2b of the display apparatus 3, 3a or 3b can further include a reflective plate and/or at least an optical film (not shown). The reflective plate can be disposed to one of the side surfaces (e.g. the surface away from the display panel 4) of the light-guiding plate 21, 21a or 21b for reflecting the light that has been emitted out through the side surface back into the light-guiding plate 21, 21a or 21b. The optical film can be a diffusion sheet, and can be disposed between the light-emitting module 2, 2a or 2b and the display panel 4 so that the light emitted from the light-emitting module 2, 2a or 2b can be formed into an average surface light source through the diffusion sheet. An interval can exist between the light-guiding plate 21, 21a or 21b and the reflective plate, or between the light-guiding plate 21, 21a or 21b and the optical film.

In addition, in another embodiment, the light-emitting module 2, 2a or 2b can function as a parallax control device of a stereoscopic display apparatus to become a parallax harrier device. By such light-emitting module 2, 2a or 2b as a parallax harrier device, when the light in an alternate form of bright and dark zones passes through the display panel 4, the left image outputted by the pixels of the display panel 4 can be transmitted to the left eye of the user while the right image outputted by the pixels of the display panel 4 can be transmitted to the right eye of the user, so that the eyes of the user can respectively receive different images with binocular parallax for forming stereoscopic images to the user without wearing a pair of glasses. To be noted, when the light-emitting module 2 functions as a parallax barrier device of a stereoscopic display apparatus, any two adjacent light-guiding elements located on the same row (along the first direction X) need to have the same interval.

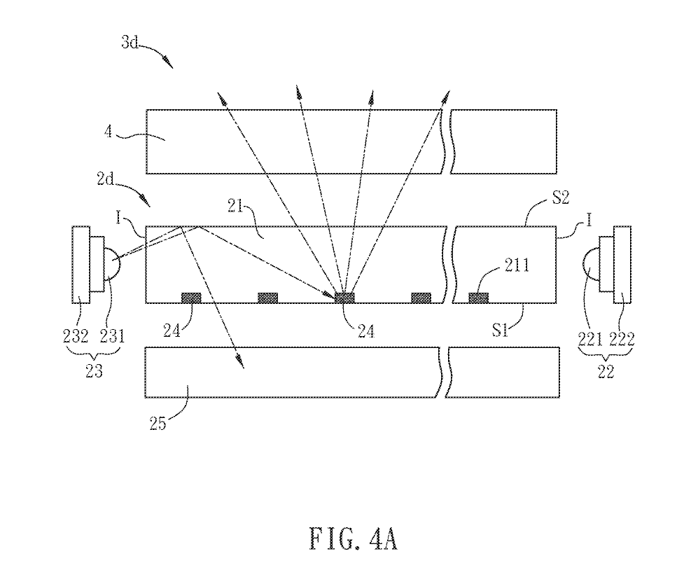

FIG. 3 is a schematic diagram of a display apparatus 3c of another embodiment of the invention.

Referring to FIG. 3, different from the display apparatus 3 in FIG. 2A, the light-guiding element 211d of the light-guiding plate 2c of the display apparatus 3c has a cross-section shaped like an arch (e.g. a semicircle) by viewing along the first direction X, and the overlooking form of the light-guiding element 211d is an ellipse-like form.

Besides, other technical features of the display apparatus 3c can be understood by referring to the display apparatus 3, so the detailed descriptions are omitted here.

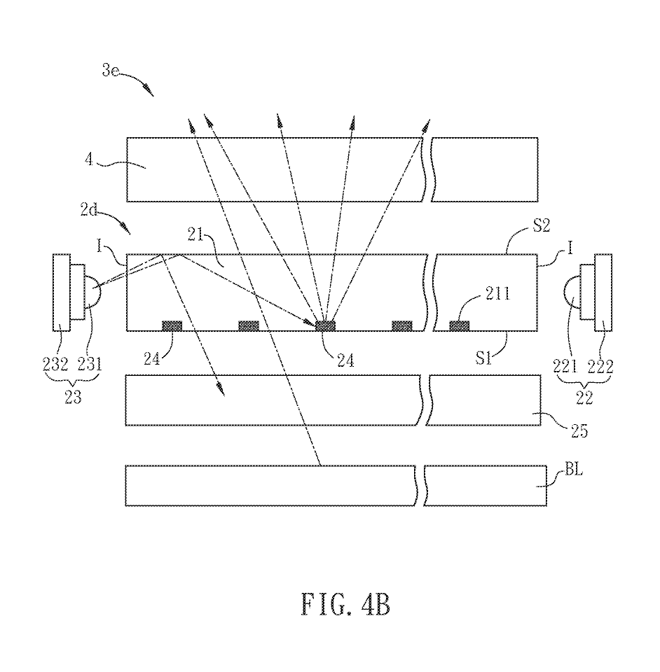

FIG. 4A is a schematic side-view of a display apparatus 3d of another embodiment of the invention.

Different from the display apparatus 3, when the light-emitting module 2d functions as the parallax barrier device of the display apparatus 3d to help the display apparatus 3d display 3D images, the light-emitting module 2d can further include a light attenuator 25 disposed to a side of the surface S1 of the light-guiding plate 21. When the light passes through the surface S1 of the light-guiding plate 21 and then enters the light attenuator 25, the light attenuator 25 can decrease (e.g. by absorbing) the light's energy to prevent the light out of the surface S1 from being reflected to enter the light-guiding plate 21 again. Therefore, light output of the light-emitting module 2d will not be interfered, and the stereoscopic display efficiency of the display apparatus 3d can be enhanced.

FIG. 4B is a schematic side-view of a display apparatus 3e of another embodiment of the invention.

Different from the display apparatus 3d, when the light-emitting module 2d functions as the parallax barrier device of the display apparatus 3e, the display apparatus 3e can further include a backlight module BL disposed on a side of the light-emitting module 2d (which is disposed between the display panel 4 and the backlight module BL) for providing the light to the display panel 4. If the display apparatus 3e displays 3D images, the backlight module BL can be turned off, but the light-emitting module 2d is turned on to emit light. If the display apparatus 3e displays 2D images, the light-emitting module 2d and the backlight module BL can both be turned on to emit light. Thereby, the display apparatus 3e can be switched to display 2D or 3D images.

Besides, other technical features of the light-emitting apparatuses 3d and 3e can be understood by referring to the display apparatus 3, so the detailed descriptions are omitted here.

In summary, the display panel of the display apparatus of the invention includes a plurality of pixels, and each of the light-guiding elements of the light-emitting module of the invention is disposed corresponding to a pixel. Besides, by viewing along the direction perpendicular to one of the surfaces of the light-guiding plate, the overlooking area of each of the light-guiding elements is larger than zero, and less than the area of the pixel corresponding to the light-guiding element. Because the light-guiding elements are disposed corresponding to pixels, respectively, and each of the light-guiding elements is with an overlooking area less than the area of the pixel corresponding to the light-guiding element, the light, emitted to the display panel through the side surface of the light-guiding plate, can be formed as curviform in an alternate form of bright and dark zones. Such light can decrease interference fringes caused by diffraction so that the display quality of the display apparatus can be enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light-emitting module cooperated with a display panel including a plurality of pixels, each of which has a plurality of sub-pixels, the light-emitting module comprising:
a light-guiding plate guiding the direction of the light and including at least a light input surface and two opposite side surfaces;
a plurality of light-guiding elements disposed on one of the side surfaces of the light-guiding plate, and disposed corresponding to pixels respectively, wherein the overlooking area of each of the light-guiding elements is larger than zero and less than the area of the pixel corresponding to the light-guiding element, by viewing along a direction perpendicular to one of the side surfaces; and
a light-emitting unit disposed to the light input surface of the light-guiding plate,
wherein the light emitted by the light-emitting unit enters the light-guiding plate, and then, by the guiding of the light-guiding plate and the light-guiding elements, the light is outputted through one of the side surfaces of the light-guiding plate in an alternate form of bright and dark zones.

2. The light-emitting module as recited in claim 1, wherein each of the light-guiding elements is shaped like a recess or a protrusion by viewing along a direction parallel with one of the side surfaces.

3. The light-emitting module as recited in claim 1, wherein each of the light-guiding elements is configured with a reflective material.

4. The light-emitting module as recited in claim 1, wherein the overlooking form of each of the light-guiding elements is a polygon, an ellipse, a circle, a “<” shape, or an irregular form by viewing along the direction perpendicular to the surface where the light-guiding elements are disposed.

5. The light-emitting module as recited in claim 1, wherein the display panel includes a first pixel and a second pixel, each of which includes at least three sub-pixels defined as a first sub-pixel, a second sub-pixel, and a third sub-pixel from left to right, and the light-guiding elements are defined as a first light-guiding element and a second light-guiding element from left to right, and the first light-guiding element is disposed corresponding to the first sub-pixel of the first pixel while the second light-guiding element is disposed corresponding to the second sub-pixel of the second pixel.

6. The light-emitting module as recited in claim 1, wherein the display panel includes a first pixel and a second pixel, each of which includes at least three sub-pixels defined as a first sub-pixel, a second sub-pixel, and a third sub-pixel from left to right, and the light-guiding elements are defined as a first light-guiding element and a second light-guiding element from left to right, and the first light-guiding element is disposed corresponding to the first sub-pixel of the first pixel while the second light-guiding element is disposed corresponding to the third sub-pixel of the second pixel.

7. The light-emitting module as recited in claim 1, wherein the display panel includes a first pixel and a second pixel, each of which includes at least three sub-pixels defined as a first sub-pixel, a second sub-pixel, and a third sub-pixel from left to right, and the light-guiding elements are defined as a first light-guiding element and a second light-guiding element from left to right, and the first light-guiding element is disposed corresponding to the first sub-pixel of the first pixel while the second light-guiding element is disposed corresponding to the first sub-pixel of the second pixel.

8. The light-emitting module as recited in claim 1, wherein each of the light-guiding elements is disposed corresponding to a sub-pixel, the overlooking area of each of the light-guiding elements is larger than zero and less than or equal to the area of the sub-pixel corresponding to the light-guiding element, by viewing along a direction perpendicular to one of the side surfaces.

9. The light-emitting module as recited in claim 1, wherein the sub-pixels corresponding to the light-guiding elements are disposed such that the geometric centers of the sub-pixels are connected by a virtual straight line, a virtual oblique line, or a virtual polyline composed of plural line segments.

10. A display apparatus, comprising:
a display panel including a plurality of pixels, each of which has a plurality of sub-pixels; and
a light-emitting module disposed opposite to the display panel and including a light-guiding plate, a plurality of light-guiding elements and a light-emitting unit, wherein the light-guiding plate guides the direction the light and includes at least a light input surface and two opposite side surfaces, and the t-guiding elements are disposed on one of the side surfaces of the light-guiding plate and each are disposed corresponding to a pixel, and the overlooking area of each of the light-guiding elements is larger than zero and less than the area of the pixel corresponding to the light-guiding element, by viewing along a direction perpendicular to one of the side surfaces, and the light-emitting unit is disposed on the light input surface of the light-guiding plate,
wherein the light emitted by the light-emitting unit enters the light-guiding plate, and then, by the guiding of the light-guiding plate and the light-guiding elements, is outputted through one of the side surfaces of the light-guiding plate in an alternate form of bright and dark zones.

11. The display apparatus as recited in claim 10, wherein each of the light-guiding elements is shaped like a recess or a protrusion by viewing along a direction parallel with one of the side surfaces.

12. The display apparatus as recited in claim 10, wherein each of the light-guiding elements is configured with a reflective material.

13. The display apparatus as recited in claim 10, wherein the overlooking form of each of the light-guiding elements is a polygon, an ellipse, a circle, a “<” shape, or an irregular form by viewing along the direction perpendicular to the surface where the light-guiding elements are disposed.

14. The display apparatus as recited in claim 10, wherein the display panel includes a first pixel and a second pixel, each of which includes at least three sub-pixels defined as a first sub-pixel, a second sub-pixel, and a third sub-pixel from left to right, and the light-guiding elements are defined as a first light-guiding element and a second light-guiding element from left to right, and the first light-guiding element is disposed corresponding to the first sub-pixel of the first pixel while the second light-guiding element is disposed corresponding to the second sub-pixel of the second pixel.

15. The display apparatus as recited in claim 10, wherein the display panel includes a first pixel and a second pixel, each of which includes at least three sub-pixels defined as a first sub-pixel, a second sub-pixel, and a third sub-pixel from left to right, and the light-guiding elements are defined as a first light-guiding element and a second light-guiding element from left to right, and the first light-guiding element is disposed corresponding to the first sub-pixel of the first pixel while the second light-guiding element is disposed corresponding to the third sub-pixel of the second pixel.

16. The display apparatus as recited in claim 10, wherein the display panel includes a first pixel and a second pixel, each of which includes at least three sub-pixels defined as a first sub-pixel, a second sub-pixel, and a third sub-pixel from left to right, and the light-guiding elements are defined as a first light-guiding element and a second light-guiding element from left to right, and the first light-guiding element is disposed corresponding to the first sub-pixel of the first pixel while the second light-guiding element is disposed corresponding to the first sub-pixel of the second pixel.

17. The display apparatus as recited in claim 10, wherein each of the light-guiding elements is disposed corresponding to a sub-pixel, the overlooking area of each of the light-guiding elements is larger than zero and less than or equal to the area of the sub-pixel corresponding to the light-guiding element, by viewing along a direction perpendicular to one of the side surfaces.

18. The display apparatus as recited in claim 10, wherein the sub-pixels corresponding to the light-guiding elements are disposed such that the geometric centers of the sub-pixels are connected by a virtual straight line, a virtual oblique line, or a virtual polyline composed of plural line segments.

19. The display apparatus as recited in claim 10, wherein the light-emitting module is a backlight module of the display apparatus.

20. The display apparatus as recited in claim 10, wherein the light-emitting module is a parallax barrier device of the display apparatus.
